(19) United States
(12) Patent Application Publication
(10) Pub. No.: US 2003/0080839 A1
(43) Pub. Date: May 1, 2003

(54) Method for improving the power handling capacity of MEMS switches

(76) Inventor: Marvin Glenn Wong, Woodland Park, CO (US)

Correspondence Address: AGILENT TECHNOLOGIES, INC., Intellectual Proerty Administration, Legal Department, DL429, P. O. Box 7599, Loveland, CO, 80537-0599, US

(21) Appl. No.: 10/004,032

(22) Filed: Oct. 31, 2001

(51) Int. Cl. H01H 51/22

(52) U.S. Cl. 335/78

(57) ABSTRACT

According to the present invention, an assembly and method is provided for preventing beams or switch contacts from overheating due to high power environments. A MEMS switch is packaged so that the beam and switch is surrounded by an inert, low viscosity, dielectric fluid. Utilizing such a construction conductively and convectively dissipates heat generated by resistive heating of the MEMS beam.

### BACKGROUND

Many conventional micromechanical switches use a deflecting beam as the actuating means for switching electrical signals. These beams are usually cantilevered beams or beams that are fixed at both ends. The beams are conventionally deflected electrostatically. However, deflection by other means, such as magnetically or thermally, is also used. Electrical contact for signal passage is made via conductive contacts closing or by bringing together capacitively coupled plates. For high power applications, capacitively coupled plates are normally used in order to prevent microwelding of metal contacts.

Another issue arises due to resistive heating of the beams during high power applications. High power applications can be of sufficient power to cause switch degradation through annealing of the beams or due to changes in the stress state in the beams. Further, losing heat from the beams is an additional issue due to the long length of the beams relative to their thickness. For instance, a beam can be approximately 300 μm long and 1-6 μm thick. Moreover, the beams are generally surrounded by gases which do not conduct heat adequately.

### SUMMARY

The present invention is directed to a microelectromechanical system (MEMS) actuator assembly. Moreover, the present invention is directed to an actuator assembly and method for improving the power handling capacity of MEMS switches.

According to the present invention, an assembly and method is provided for preventing beams or switch contacts from overheating due to high power environments. A MEMS switch is packaged so that the beam and switch is surrounded by an inert, low viscosity, dielectric fluid. Utilizing such a construction conductively and convectively dissipates heat generated by resistive heating of the MEMS beam. Further, surrounding the beam with an inert, low viscosity, dielectric fluid allows local cooling of switch contacts during opening and closing thus preventing overheating and microwelding of the contacts.

The MEMS beam and associated structures (e.g. capacitive and actuator plates) may have perforations to allow fluid passage and to provide less hydrodynamic drag as the beam and associated structures move through the fluid. These perforations act to minimize any time penalty associated with operating in a fluid medium.

### DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 shows a cross sectional side view of a MEMS switch in accordance with the invention.

FIG. 2 shows a bottom view of the long arm of a piezoelectric beam with perforations in accordance with the invention.

FIG. 3 shows an alternate cross sectional view of a MEMS switch in accordance with the invention.

### DETAILED DESCRIPTION OF THE INVENTION

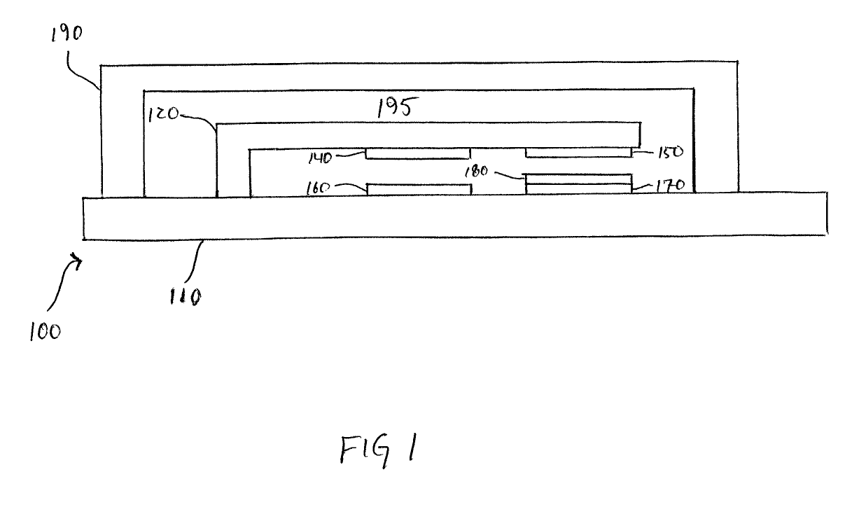

The MEMS switch 100 shown, shown in FIG. 1, includes a substrate 110 which acts as support for the switching mechanism and provides a non-conductive dielectric platform. The MEMS switch 100 shown in FIG. 1 also includes deflecting beam 120 connected to the substrate 110. In common fashion, the deflecting beam 120 forms an L shape with the short end of the deflecting beam 120 connecting to the substrate. The deflecting beam 120 is constructed from a non-conductive material. The deflecting beam 120 has an attracted plate 140 and a first signal path plate 150 connected to the long leg. An actuator plate 160 is connected to the substrate directly opposing the attracted plate. A second signal path plate 170 is connected to the substrate directly opposing the signal path plate 150.

During operation of the MEMS switch shown in FIG. 1, a charge is applied to actuator plate 160 causing attracted plate 140 to be electrically attracted thereto. This electrical attraction causes bending of the deflecting beam 130. Bending of the deflecting beam 120 causes the first signal path plate 150 and the second signal path plate 170 to near each other. The nearness of the first and second signal path plates 150, 170 causes capacitive coupling, thus allowing the switch 100 to achieve an “on” state. To turn the switch off, the voltage difference between the actuator plate 160 and the attracted plate 140 is removed and the deflecting beam returns to its undeflected position.

A dielectric pad 180 is commonly attached to one or both of the signal path plates 150, 170. A dielectric pad is not shown attached to the signal plate 150 in FIG. 1. The dielectric pad prohibits the signal path plates 150, 170 from coming in contact during the bending of the deflecting beam. It is understood by those skilled in the art that electrostatically actuated micromachined high-power switches pass the signals capacitively because conduction by metal-to-metal can cause the contacts 150, 170 to micro-weld. Further, the high heat present in a high power capacitive MEMS switch can cause annealing of the deflecting beam 130 also resulting in a short circuited MEMS switch.

It is understood by those skilled in the art that high power capacitive MEMS switches can be constructed in a variety of manners. Any capacitive MEMS switch is susceptible to annealing, melting, welding or other heat induced phenomena.

A dielectric packaging 190 surrounds the MEMS switch 100 in FIG. 1. The packaging connects to the substrate 110 and provides an airtight chamber 195 around the MEMS switch 100. The chamber 195 is filled with a suitably inert (non-reactive with the components of the MEMS switch 100 and chamber 195, and electrochemically unreactive in the chemical and electrical environment existing within the switch chamber 195), low viscosity (e.g. 0.4-0.8 cs), dielectric fluid. In a preferred embodiment of the invention, the chamber 195 is filled with a low molecular weight (e.g. m.w. 290-420) perfluorocarbon. In a more preferred embodiment of the invention, the chamber 110 is filled with Fluorinert™ FC-77. Fluorinert™ is a register trademark of 3M. Heat generated by resistive heating of the MEMS switch 100 is dissipated to the fluid contained in the chamber 195. The presence of the fluid in the chamber also allows local cooling of the signal path plates 150, 170 during opening and closing thus preventing overheating and microwelding of the signal path plates 150, 170.

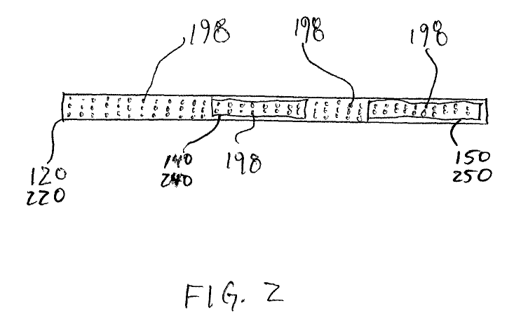

The MEMS deflecting beam 120, attracted plate 140 and signal path plates 150 may have perforations 198 to allow fluid passage therethrough. FIG. 2 shows a bottom view of the long arm of a piezoelectric beam 120 with perforations 198 in accordance with the invention. The perforations allow for increased cooling of the affected structures of the MEMS switch 100 and provide for less hydrodynamic drag as the perforated structures 120, 140, 150 move through the fluid. The switching time penalty for operating in a fluid is thus minimized. As is understood by those skilled in the art, perfluorocarbons generally have good lubricity so that friction is minimized.

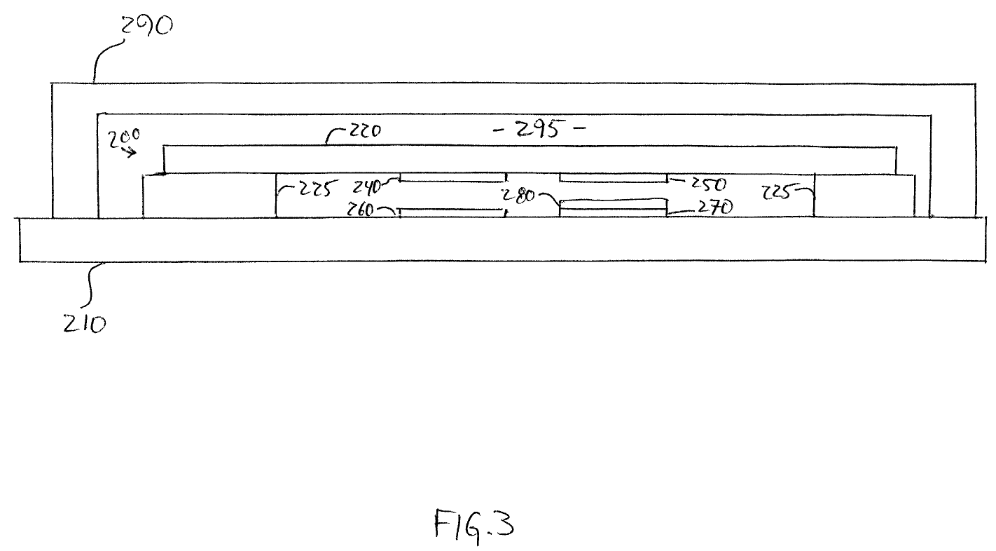

FIG. 3 shows an alternate cross sectional view of a MEMS switch 200 in accordance with the invention. The MEMS switch 200 shown, shown in FIG. 3, includes a substrate 210 which acts as support for the switching mechanism and provides a non-conductive dielectric platform. The MEMS switch 200 shown in FIG. 1 also includes deflecting beam 220 connected which is fixed at each end to a beam support 225. The beam supports 225 are attached to the substrate 210. The deflecting beam 220 is constructed from a non-conductive material. The deflecting beam 220 has an attracted plate 240 and a first signal path plate 250 connected to the long leg. An actuator plate 260 is connected to the substrate directly opposing the attracted plate. A second signal path plate 270 is connected to the substrate directly opposing the signal path plate 250.

During operation of the MEMS switch shown in FIG. 3, a charge is applied to actuator plate 260 causing attracted plate 240 to be electrically attracted thereto. This electrical attraction causes bending of the deflecting beam 220. Bending of the deflecting beam 220 causes the first signal path plate 250 and the second signal path plate 270 to near each other. The nearness of the first and second signal path plates 250,270 causes capacitive coupling, thus allowing the switch 200 to achieve an “on” state. To turn the switch off, the voltage difference between the actuator plate 260 and the attracted plate 240 is removed and the deflecting beam returns to its undeflected position.

A dielectric pad 280 is commonly attached to one or both of the signal path plates 250,270. A dielectric pad is not shown attached to the signal plate 250 in FIG. 3. The dielectric pad prohibits the signal path plates 250,270 from coming in contact during the bending of the deflecting beam. It is understood by those skilled in the art that electrostatically actuated micromachined high-power switches pass the signals capacitively because conduction by metal-to-metal can cause the contacts 250,270 to micro-weld. Further, the high heat present in a high power capacitive MEMS switch can cause annealing of the deflecting beam 220 also resulting in a short circuited MEMS switch.

It is understood by those skilled in the art that high power capacitive MEMS switches can be constructed in a variety of manners. Any capacitive MEMS switch is susceptible to annealing, melting, welding or other heat-induced phenomena.

A dielectric packaging 290 surrounds the MEMS switch 200 in FIG. 1. The packaging connects to the substrate 210 and provides an airtight chamber 295 around the MEMS switch 200. The chamber 295 is filled with a suitably inert (non-reactive with the components of the MEMS switch 200 and chamber 295, and electrochemically unreactive in the chemical and electrical environment existing within the switch chamber 295), low viscosity (e.g. 0.4-0.8 cs), dielectric fluid. In a preferred embodiment of the invention the chamber 295 is filled with a low molecular weight (e.g. m.w. 290-420) perfluorocarbon. In a more preferred embodiment of the invention, the chamber 110 is filled with Fluorinert™ FC-77. Fluorinert™ is a register trademark of 3M. Heat generated by resistive heating of the MEMS switch 200 is dissipated to the fluid contained in the chamber 295. The presence of the fluid in the chamber also allows local cooling of the signal path plates 250,270 during opening and closing thus preventing overheating and microwelding of the signal path plates 250,270.

The MEMS deflecting beam 220, attracted plate 240 and signal path plates 250 may have perforations 298 to allow fluid passage therethrough. FIG. 2 shows a deflecting beam 220 and signal plates 240,250 with perforations. The perforations allow for increased cooling of the affected structures of the MEMS switch 200 and provide for less hydrodynamic drag as the perforated structures 220,240,250 move through the fluid. The switching time penalty for operating in a fluid is thus minimized. As is understood by those skilled in the art, perfluorocarbons generally have good lubricity so that friction is minimized.

While only specific embodiments of the present invention have been described above, it will occur to a person skilled in the art that various modifications can be made within the scope of the appended claims.

What is claimed is:

1. A micromachined electromagnetic switch comprising:
a dielectric substrate;
a deflecting beam connected to said substrate;
a first signal path plate connected to said beam;
a second signal path plate connected to said substrate;
an actuator plate connected to said beam; and
an attracted plate connected to said beam;
wherein a packaging connected to said forms a chamber surrounding said micromachined electromagnetic switch and wherein said chamber is filled with dielectric perfluorocarbon.

2. The micromachined electromagnetic switch of claim 1, wherein said perfluorocarbon is a substantially inert fluid.

3. The micromachined electromagnetic switch of claim 2, wherein said fluid has a low viscosity.

4. The micromachined electromagnetic switch of claim 3, wherein said deflecting beam is a cantilever beam.

5. The micromachined electromagnetic switch of claim 3, wherein said deflecting beam is a beam fixed at both ends.

6. The micromachined electromagnetic switch of claim 3, wherein there are perforations present in said deflecting beam, said attracted plate and said first signal path plate.

7. A micromachined electromagnetic switch for switching electrical signals comprising a deflecting beam and an actuating means for switching said electrical signals, wherein said micromachined electromagnetic switch is surrounded by a dielectric substance, said substance providing an airtight chamber which is filled with a dielectric fluid.

8. The micromachined electromagnetic switch of claim 7 wherein said fluid is a perfluorocarbon.

9. The micromachined electromagnetic switch of claim 8 wherein said perfluorocarbon is substantially inert, has a low viscosity and has a low molecular weight.

10. The micromachined electromagnetic switch of claim 7, wherein said deflecting beam is a cantilever beam.

11. The micromachined electromagnetic switch of claim 7 wherein said deflecting beam is a beam have a first and a second end and which is fixed at said first and said second end.
